(19) United States
(12) Patent Application Publication
(10) Pub. No.: US 2006/0088645 A1
(43) Pub. Date: Apr. 27, 2006

(54) Omega-3 food product and related method of manufacture

(75) Inventors: Troy P. Nietling, Lowell, MI (US); Eugene R. Maly, Kentwood, MI (US)

Correspondence Address: WARNER, NORCROSS & JUDD;IN RE: ALTICOR INC., INTELLECTUAL PROPERTY GROUP, 111 LYON STREET, N. W. STE 900, GRAND RAPIDS, MI, 49503-2489, US

(73) Assignee: Access Business Group International LLC

(21) Appl. No.: 11/255,330

(22) Filed: Oct. 21, 2005

Related U.S. Application Data
(60) Provisional application No. 60/621,378, filed on Oct. 22, 2004.

(51) Int. Cl. A23D 9/00

(52) U.S. Cl. 426/601

(57) ABSTRACT

A food composition including a fish oil containing omega-3 fatty acids, a food grade acid and a flavoring agent, the food grade acid and flavoring agent neutralizing the aroma and/or flavor of the fish oil. Lemonade flavoring can be added to the composition to further neutralize the fish oil aroma and/or flavor. The food grade acid can be citric acid present in an amount of about 0.8% to about 4% by weight of the composition. The flavoring agent can be a lemon flavor ingredient present in an amount of about 0.02% to about 2% by weight, and/or a mango flavoring present in an amount of about 0.5% to about 3% by weight. The optional lemonade flavoring agent can be present in an amount of about 0.5% to about 3.5% by weight. The fish oil can be encapsulated and further immobilized in a gelatin matrix of a gummi-type product to further eliminate the fish aroma and/or flavor.

This application claims benefit of U.S. Provisional Application No. 60/621,378, filed Oct. 22, 2004, which is hereby incorporated by reference.

### BACKGROUND OF THE INVENTION

The present invention relates to a food product including fish oil, the food product free from a fish aroma and/or a fish flavor.

Fish oil is rich in polyunsaturated fatty acids, such as α-linolenic acid, eicosapentaenoic acid (EPA), and docosahexaenoic acid (DHA). These fatty acids are referred to as “omega-3 fatty acids” because they include a double bond at the third carbon from the omega position of the fatty acid.

Consumption of fish oil containing omega-3 fatty acids can provide many positive health effects in humans and animals. For example, nutrition and medical experts have recently recognized that omega-3 fatty acids from fish oil provide heart health benefits, reduce levels of triglycerides, reduce levels of low density lipoprotein, and reduce cholesterol.

Many efforts have been made to incorporate fish oil containing omega-3 fatty acids into food products. These efforts, however, generally have been unsuccessful because fish oil containing omega-3 fatty acids inherently have an unsavory fish aroma and flavor. Moreover, the fish oil in most food products is susceptible to oxidation, which diminishes the omega-3 fatty acid content of the fish oil.

Due to the unpleasant, fishy aroma and/or flavor of conventional food products including fish oil, many people, especially children, have diets that are low in beneficial omega-3 fatty acids. There exists a need to provide a food product that includes fish oil, but lacks a fish aroma and/or flavor.

### SUMMARY OF THE INVENTION

The aforementioned goals are met by a food product including a fish oil having omega-3 fatty acids, a food grade acid, and/or a flavoring agent, wherein the food grade acid and the flavoring agent mask the fishy aroma and/or flavor of the oil.

In one embodiment, the fish oil can be microencapsulated in a gelatin shell. The microencapsulated fish oil can also be further dispersed in a gelatin base, along with other ingredients, for example sugar and glucose syrup, to create a “gummi” confectionary food product.

In another embodiment, the food grade acid can be citric acid, and can mask all or a portion of the fishy aroma and/or flavor. The citric acid can be present in an amount of about 0.8% to about 4% by weight of the composition, and optionally about 2.5%.

In a third embodiment, the flavoring agent can be a lemon flavoring agent, natural or artificial, and can mask all or a portion of the fishy aroma and/or flavor. The lemon flavoring agent can be present in an amount of about 0.02% to about 2% by weight, and optionally about 0.25%.

In a fourth embodiment, the flavoring agent can be a mango flavoring agent, natural or artificial, and can mask all or part of the fishy aroma and/or flavor. The mango flavoring agent can be present in an amount of about 0.5% to about 3% by weight, and optionally about 1.4%.

In a further embodiment, the flavoring agent can be a lemonade flavoring agent, natural or artificial, and can mask all or a portion of the fishy aroma and/or flavor. The lemonade flavoring agent can be present in an amount of about 0.5% to about 3.5% by weight, and optionally about 1.15%.

In a sixth embodiment, the citric acid, lemon flavoring agent and lemonade flavoring agent can cooperate to collectively mask the fishy aroma and/or flavor in the food product by each masking a portion of the fishy aroma and/or flavor.

In a seventh embodiment, the citric acid and mango flavoring agent can cooperate to collectively mask the fishy aroma and/or flavor in the food product by each masking a portion of the fishy aroma and/or flavor.

A method for making the food product includes: providing an encapsulated fish oil including omega-3 fatty acids; mixing citric acid, in an amount of about 0.8% to about 4% by weight of food product, with the fish oil; and mixing lemon flavoring, in an amount of about 0.1% to about 2% by weight of the food product, with the fish oil to form a food product. Optionally, lemonade flavor, in an amount of about 0.5% to about 3.5% by weight can be mixed with the fish oil. Further optionally, lemon flavoring can be absent, and mango flavoring, in an amount of about 0.5% to about 3% by weight, can be mixed with the fish oil.

The present food product provides many benefits. First, for example, the food product includes fish oil having omega-3 fatty acids without a fishy flavor and/or aroma. Second, when mixed with confectionary ingredients to create a gummi-type food product, that food product can be extremely appealing to children, which makes it easier to administer omega-3 fatty acids to the children. Third, when the microencapsulated fish oil is mixed with a gelatin base in a confectionary product to form a gummi matrix, the overall stability of the fish oil, and oxidation resistance of the component omega-3 fatty acids is improved. Fourth, with the microencapsulated fish oil, the product can release that oil in the upper portion of the intestine, which provides efficient absorption of the fish oil without unpleasant side effects, such as regurgitation of the fish oil (also referred to as “burp back”), or fishy breath, or aftertaste.

These and other objects, advantages and features of the invention will be more readily understood and appreciated by reference to the detailed description of the invention and the drawings.

### BRIEF DESCRIPTION OF THE DRAWINGS

FIG. 1 is a graph that illustrates the masking of a fish oil aroma/flavor with one embodiment of the food product;

FIG. 2 is a graph that illustrates the masking of a fish oil aroma/flavor with an alternative embodiment of the food product; and

FIG. 3 is a flow diagram showing a process for manufacturing the food product.

### DETAILED DESCRIPTION OF THE INVENTION

I. Composition

The food product includes fish oil, food grade acid, and one or more flavoring agents. Other ingredients, such as confectionary ingredients and vitamins can be added to the food product as desired. A description of the ingredients is below.

The food product is described herein in connection with a gummi-type food product; however, it is suited to be incorporated into a variety of different confectionary products, supplements, and food stuffs. The food product can be administered as an omega-3 fatty acid supplement in selected dosages to provide a desired level of omega-3 fatty acids in a diet, and thereby provide the beneficial effects of the omega-3 fatty acids to the subject. For example, in an embodiment where the food product is included in a gummi-type food product, and where the gummi-type product weighs about 3 grams, four such gummi-type products provide about 150 milligrams of omega-3 fatty acids. Other dosages and divisions of servings per product may be utilized as desired.

Surprising and unexpected results of substantially complete elimination of the fishy aroma and flavor of the food product, and maintaining sensory freshness for an extended period of time were achieved when the below amounts of citric acid and lemon flavor were used in the food product. At least one of the citric acid and lemon flavoring agent operates to overwhelm the flavor and taste receptors of subjects with a tart and/or sour flavor and aroma at substantially the same time that the fish oil aroma and flavor hit the same receptors. In some embodiments, where lemonade flavoring is added to the product, this flavoring agent can also mask the fishy aroma and/or flavor of the product.

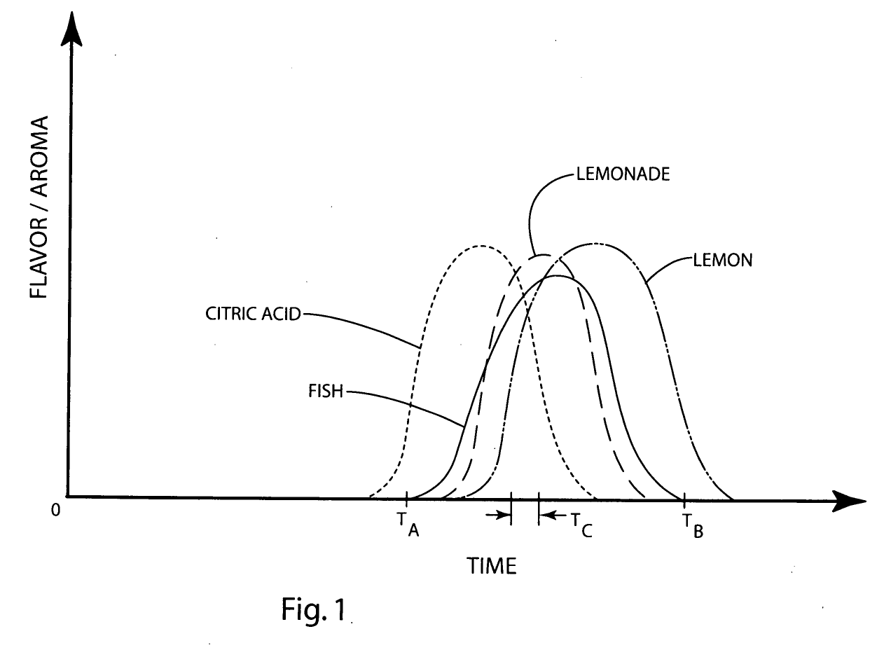

A first example of the phenomenon with regard to flavor and aroma after administration of the product to a subject is illustrated in FIG. 1. As shown there, the vertical axis indicates the flavor and/or aroma experienced by a subject; and the horizontal axis indicates the passage of time. As can be seen, the fishy flavor and/or aroma from fish oil of the food product is appreciable between times T_{A} and T_{B}. In this figure, which is representative of the formula explained in Examples 1, 3 and 5, below, the lemon flavoring and citric acid of the product mask the perception of the fish flavor and/or aroma during this time. For example, citric acid masks the first portion of the fish flavor and/or aroma; and lemon flavoring masks another portion of the fish flavor and/or aroma perception.

Sometimes, however, the fish flavor and/or aroma is perceivable for a small amount of time T_{C} due to a gap in the masking ability of the lemon flavoring agent and the citric acid. If such a gap exists, a lemonade flavoring agent optionally can be added to the composition to mask the fish during this time T_{C}. In this manner, the fish flavor and/or aroma are masked throughout the time T_{A} through T_{B}, during which these characteristics would be perceived by a subject.

The flavoring agent can also be a mango flavoring agent, which can be substituted for, or in addition to, the lemon flavoring agent and/or the lemonade flavoring agent. One suitable mango flavoring agent is mango flavor, available from Flavors of North America located in Geneva, Ill. The mango flavoring agent can be present in an amount having a lower limit of about 0.1%, 0.25%, 0.5%, 0.75% or 1% by weight, and an upper limit of about 1.25%, 1.4%, 1.5%, 1.75%, 2%, 2.5%, 3%, or 3.5% by weight, and optionally about 1.4%.

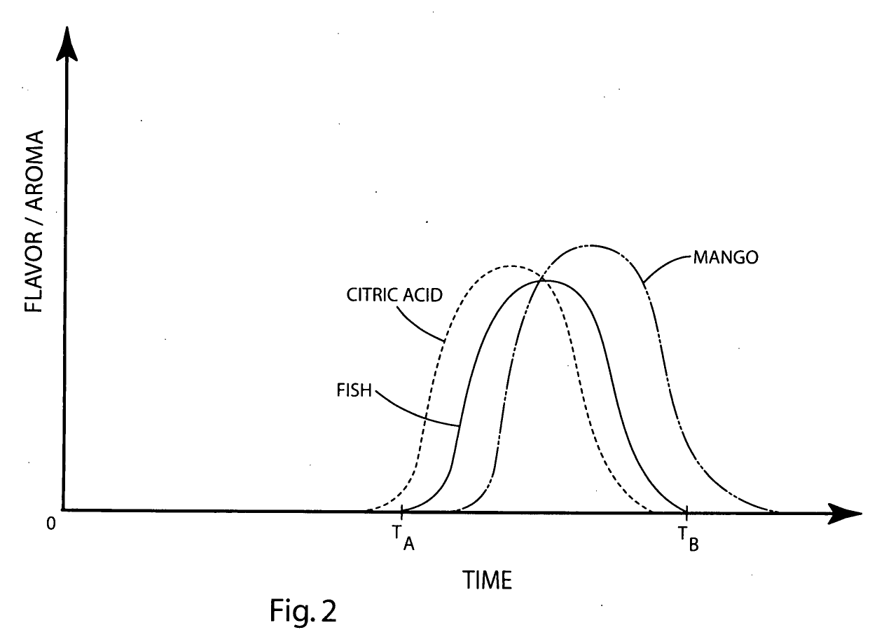

A second example of the phenomenon with regard to flavor and aroma after administration of the product including a mango flavoring agent is illustrated in FIG. 2. As shown there, the vertical axis indicates the flavor and/or aroma experienced by a subject; and the horizontal axis indicates the passage of time. As can be seen, the fishy flavor and/or aroma from fish oil of the food product is appreciable between times T_{A} and T_{B}. In this figure, which is representative of the formula explained in Example 5, the mango flavoring and citric acid of the product mask the perception of the fish flavor and/or aroma during this time. For example, citric acid masks the first portion of the fish flavor and/or aroma; and mango flavoring masks the later portion of the fish flavor and/or aroma perception. The mango can mask the fish flavor for a period long enough to cover up the fish flavor as the citric acid flavor/aroma begins. In other words, the fish flavor and/or aroma are masked throughout the time T_{A} through T_{B}, during which these characteristics would be perceived by a subject.

A. Fish Oil

The food product can include any suitable oil, having as a constituent one or more omega-3 fatty acids, for example, oils prepared from fish containing omega-3 fatty acids, either alone or in combination, with other oils or any other suitable components. Combined oils, for example, those containing oils prepared from fish as well as oils from other sources, such as plant or animals, are suitable. The fish oil can be produced from any suitable source including bonito, herring, capelin, anchovy, cod, liver, salmon, mackerel, menhaden, salmonids, sardines, shark, tuna and mixtures thereof.

The oil can be encapsulated in a shell, such as a gelatin shell, to form oil microcapsules. The particle size of the microcapsules can be between about 0.1 and about 5,000 microns, or about 10 to about 1,000 microns, or any other size depending on the application. Those of ordinary skill in the art will appreciate that gelatins used for microencapsulating oils are generally stable in high heat conditions. The oil microcapsules can be washed with water and/or dried to provide a free flowing powder. Suitable spray dried, microencapsulated fish oil powder can be commercially obtained from Ocean Nutrition Canada of Nova Scotia, Canada. Such fish oil powder from Ocean Nutrition can include about 60% fish oil. The amount of fish oil powder used in the food product can be present in amounts having a lower limit of about 1%, 5%, 6%, 7%, 8%, 10%, 20%, 30%, 40% or 50% by weight, and an upper limit of about 80%, 60%, 70%, 50%, 40%, 30%, 20% or 10% by weight, and optionally about 7.3%.

B. Food Grade Acid

The food product can include a food grade acid. This food grade acid can be citric acid; however, other suitable acids include, for example, lactic acid, malic acid, ascorbic acid, or phosphoric acid. One suitable food grade acid includes a combination of lactic acid and citric acid (46% lactic acid and 32% citric acid by weight), and is sold under the name Purac CL 80%, (“Purac CL 21/80”) which is available from PURAC America of Lincolshire, Ill. The food grade acid, for example, citric acid, can be present in amounts with a lower limit of about 0.8%, 1%, 1.25%, 1.5%, 1,75%, 2% or 2.5% by weight, and an upper limit of about 2.75%, 3%, 3.25%, 3.5%, 3.75% or 4% by weight, and optionally about 3.1%.

C. Flavoring Agent

The food product includes one or more flavoring agents. The flavoring agent can be a lemon flavoring agent; however, other suitable flavoring agents include, for example, mango, orange, lime, pineapple, grapefruit, cinnamon, clove and various mints—natural or artificial. One suitable lemon flavoring agent is WONF lemon flavoring available from Sensient Flavors, Inc. of Indianapolis, Ind. The lemon flavoring agent can be a lemon oil extract, and can be present in amounts having a lower limit of about 0.02% by weight, and an upper limit of about 2% by weight; a lower limit of about 0.2% by weight, and an upper limit of about 0.3% by weight; and optionally about 0.25%. In some applications, when the lemon flavoring is much less than about 0.2% by weight, a fish flavor can begin to be perceived in sensory testing. In some applications, when lemon flavoring is much above about 0.3% by weight, a flavor burn can begin to be perceived by subjects in sensory testing.

The flavoring agent can also be a lemonade flavoring agent, natural or artificial, which can be substituted for, or in addition to, the lemon flavoring agent. One suitable lemonade flavoring agent is lemonade flavor, also available from Sensient. The lemonade flavoring agent can be present in amount having a lower limit of about 0.1%, 0.25%, 0.5%, 0.75% or 1% by weight, and an upper limit of about 1.25%, 1.4%, 1.5%, 1.75%, 2%, 2.5%, 3%, or 3.5% by weight, and optionally about 1.15%.

The flavoring agent can also be a mango flavoring agent, natural or artificial, which can be substituted for, or in addition to, the lemon flavoring agent and/or the lemonade flavoring agent. One suitable mango flavoring agent is mango flavor, available from Flavors of North America located in Geneva, Ill. The mango flavoring agent can be present in an amount having a lower limit of about 0.1%, 0.25%, 0.5%, 0.75%, 1%, 1.3%, 1.4%, 1.5%, 1.75%, 2%, 2.25%, 2.5%, 2.75%, 3% or 4% by weight and an upper limit of about 3%, 3.5%, 4%, 4.5%, 5%, 6%, 7%, 8%, 9%, 10% or 11% by weight, and optionally about 1.4%.

D. Confectionary Ingredients

The food product can include various confectionary ingredients. In one embodiment, the food product is incorporated into a gummi-type product, for example, candy gummi worms, gummi bears and other gummi-type products. Gummi-type products can have properties of elasticity and compressibility. Confectionary ingredients, such as corn syrup, sucrose syrup, glucose syrup and other natural and artificial sweeteners, can be added to the product. Such ingredients are conventional, and will not be described in detail here. Varying amounts of these ingredients may be used as desired. Alternatively, the gummi-type product can be “sugar-free”, and can include polyalcohols, such as maltitol and sorbitol to provide a desired sweetness. Optional coloring, such as caramel color, can be added as desired. Further, optional waxes such as carnauba wax can be added to the food product as desired.

To create the gummi-type texture of the product, gelatin can be added to the product. Again, varying amounts of gelatin may be used. In some applications, gelatins that exhibit about 225 to about 300 Blooms showed good results.

Surprising and unexpected results were discovered when microencapsulated fish oil was incorporated into a gummi-type product. Specifically, the gummi-type product exhibited much-improved stability and resistance to oxidation of the omega-3 fatty acids present in the fish oil. It is believed that by enveloping the microencapsulated fish oil in yet another matrix of gelatin provides a double barrier to prevent oxidation of the fatty acids in the fish oil.

E. Vitamins and Additional Ingredients

The food product can include additional ingredients to enhance the antioxidant and/or other beneficial efficacy of the product. In one example, the composition can include an acerola concentrate blend, available from Nutrilite of Lakeview, Calif., present in an amount of about 0.01% to about 5%, and optionally about 0.05% by weight; ascorbic acid present in an amount of about 0.01% to about 1.1% by weight, and optionally about 0.15% by weight; tocopherols, for example, mixed tocopherols, such as T90 mixed tocopherols and F1000 mixed tocopherols, commercially available from Cognis Corp of LaGrange, Ill., present in an amount of about 0.01% to about 5% by weight, and optionally about 0.4% by weight; and/or vitamin E with 67% d-α-tocopherols, present in an amount of about 0.01% to about 0.1%, and optionally about 0.05% by weight. Other vitamins, antioxidants and phytonutrients can be added as desired.

II. Method of Manufacture

A general method for manufacturing a food product will now be described in connection with an exemplary gummi-type food product. In one step, gelatin is hydrated. Pectin is added to the hydrated gelatin. Confectionary ingredients, for example, corn syrup and hydrogenated glucose syrup are added. Fish oil powder and sucrose are preblended together, and then this mixture is also added. In some applications, preblending of the fish oil powder and sucrose facilitates mixing the fish oil powder homogeneously with the other ingredients.

In another step, the mixed ingredients are cooked using a standard direct steam injection cooker or a jet cooker at about 245° F. to about 280° F. In one embodiment, it was observed that cooking with the jet cooker provided a higher level of de-aeration of the product, which resulted in a clearer finished gummi-type product.

The ingredients are then cooled to about 160° F. to about 200° F. A lemon flavor and/or mango flavor, and optional lemonade flavor, are added. Citric acid can be added last to the mixture. In some applications, addition of the citric acid last facilitates setting-up of the pectin to form a solidified matrix.

With the addition of the ingredients completed, the pourable material can be poured into a starch mold that includes recesses formed to the shape of a desired design, for example, a starfish, a shell, a fish or a bear. The material is allowed to cool for about 24 to 48 hours in a cool, dry chamber. During this cooling, the starch can optionally pull moisture from the material.

After the gummi-type products are fully formed, they are removed from the starch and can be further processed, for example, by sugar-coating or adding an oil to the surface to prevent sticking. Finished gummi-type products are then packaged.

The following examples are presented for the purpose of further illustrating and explaining the present invention and are not to be taken as limiting in any regard. Unless otherwise indicated, all parts and percentages are by weight.

### EXAMPLE 1

In this example, a gummi-type product was manufactured to include the ingredients in Table I.

TABLE I
Example 1 Ingredients

| | % of Formula |
|---|---|
| Ingredients | by Weight |
| Corn Syrup | 25.49 |
| Sucrose | 34.39 |
| Glucose Syrup, Hydrogenated | 2.50 |
| Purified Water | 2.50 |
| Nat. Tumeric 8% | 0.02 |
| Gelatin (250 Bloom) | 5.00 |
| Purified Water | 7.00 |
| Citric Acid | 2.50 |
| Purified Water | 12.50 |
| Fish Oil Powder | 6.70 |
| Lemon Flavor | 0.25 |
| Lemonade Flavor | 1.15 |
| Total | 100.00 |

The ingredients in Table I were mixed and processed according to the following method.

In one step, the corn syrup, sucrose, glucose syrup and water were combined and mixed. In another step, the resulting mixed contents were heated to a rolling boil of about 102° to about 108° C. for 50 to 60 seconds. Brix was monitored to ensure it was about 86 to 87. The heated syrup was removed from heat, and cooled to 85° C. Additional colorant was mixed with the above ingredients, the mixture was placed in a sonicator bath, and covered with aluminum foil to drive out air.

In another step, gelatin and water were mixed and placed in hot or boiling water, and mixed periodically until reaching about 70° C.

The syrup was removed from the sonicator bath and the gelatin slowly added to the syrup. The components were mixed so that they gelled slightly. Further mixing in the sonicator bath was performed until the contents were uniformly mixed. The contents were then covered and further deaerated.

In another step, a fish oil powder slurry was added to the batch. Lastly, the flavoring and citric acid mixture is added. Further mixing in the sonicator bath was performed until the mixture was again homogenous.

The mixture was allowed to further deaerate. The prepared material was deposited in starch molds and allowed to set at room temperature for about 24 hours. Thereafter, the gummi-type products are removed and packaged as desired.

After being manufactured, the gummi-type product of this Example was tested for aroma, appearance, flavor, texture and overall opinion.

The product was tested by a group of subjects for the sensory attributes in the Table II below. Each attribute was measured on a scale of about 0 to about 9; 0 being “dislike extremely;” and 9 being “like extremely.”

TABLE II
Example 1 Sensory Attribute Testing

| | | | | | | | | | Overall | |
|---|---|---|---|---|---|---|---|---|---|---|
| | Aroma | | Appearance | | Flavor | | Texture | | Opinion | |
| | 85 Subjects | | 85 Subjects | | 85 Subjects | | 85 Subjects | | 85 Subjects | |
| Ratings | N | % | N | % | N | % | N | % | N | % |
| Dislike Extremely (1) | 0 | 0 | 0 | 0 | 0 | 0 | 0 | 0 | 0 | 0 |
| Dislike Very Much (2) | 5 | 6 | 0 | 0 | 2 | 2 | 1 | 1 | 1 | 1 |
| Dislike Moderately (3) | 4 | 5 | 0 | 0 | 0 | 0 | 1 | 1 | 1 | 1 |
| Dislike Slightly (4) | 4 | 5 | 0 | 0 | 1 | 1 | 4 | 5 | 1 | 1 |
| Neither Like Nor Dislike (5) | 45 | 53 | 2 | 2 | 0 | 0 | 3 | 4 | 2 | 2 |
| Like Slightly (6) | 5 | 6 | 7 | 8 | 9 | 11 | 7 | 8 | 11 | 13 |
| Like Moderately (7) | 14 | 16 | 22 | 26 | 21 | 25 | 20 | 24 | 20 | 24 |
| Like Very Much (8) | 6 | 7 | 38 | 45 | 36 | 42 | 33 | 39 | 37 | 44 |
| Like Extremely (9) | 2 | 2 | 16 | 19 | 16 | 19 | 16 | 19 | 12 | 14 |

According to Table II, the aroma, appearance, flavor, texture and overall opinion were generally liked moderately or very much. This indicates the absence of detectable fish aroma and/or flavor, and a well-balanced flavor/aroma generated by the acids and flavoring.

### EXAMPLE 2

In this example, a gummi-type product was manufactured to include the ingredients in Table III. Testing of aroma, appearance, sweetness, sourness, flavor, mouthfeel and overall opinion of the gummi-type product was performed.

TABLE III
Example 2 Ingredients

| | % of Formula |
|---|---|
| Ingredient | by Weight |
| Sucrose, Fruit Granulation | 33.81 |
| Corn Syrup, 42-43 D.E. | 34.79 |
| Water, Purified | 13.08 |
| Omega 3, DHA powder | 7.34 |
| Gelatine, porcine | 4.72 |
| Citric/Lactic Acid Solution | 3.10 |
| Crystaline Sorbitol | 1.00 |
| Lemonade flavor, Natural | 1.15 |
| Pectin | 0.50 |
| Natural Lemon Flavor | 0.25 |
| Ascorbic Acid, Granular, USP | 0.15 |
| Vitamin E, d-α-tocopherol, 67% | 0.05 |
| Acerola Concentrate, Blend | 0.05 |
| Tocopherols, Natural mixed | 0.01 |
| Total | 100.00 |

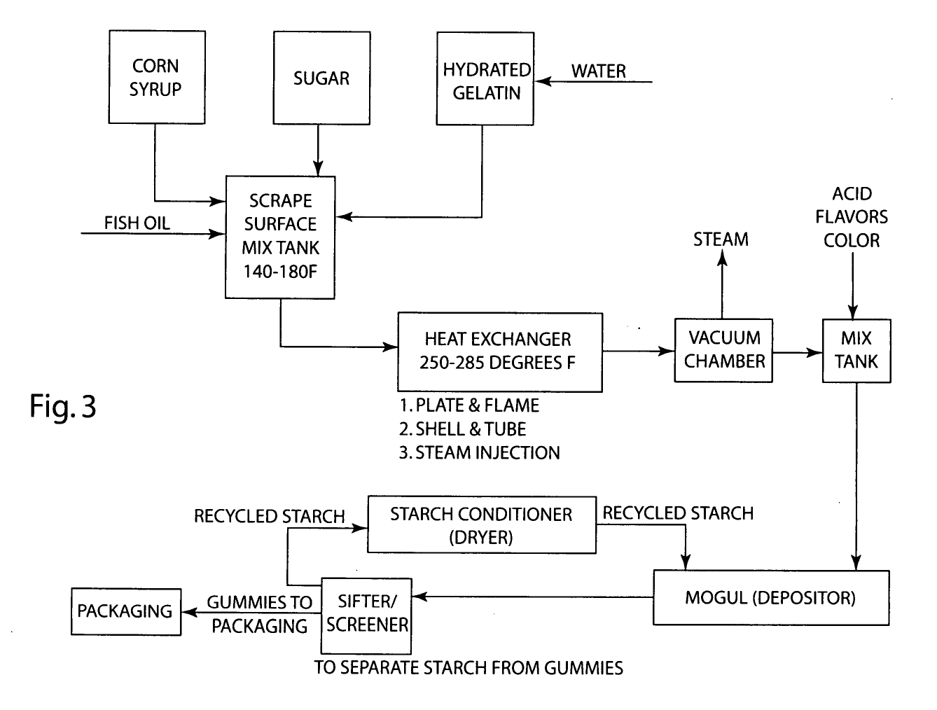

FIG. 3 illustrates a flow chart of the process used to prepare the gummi food products with the ingredients of Table III. Pectin was hydrated in water at 180° F. Gelatin was added to the hydrated pectin. The corn syrup, sucrose and gelatin were added to the mix tank at 140° F.-180° F. to produce a confectionary gelatin matrix; however, one or more of the ingredients (the corn syrup, sucrose, gelatin and/or fish oil) may be absent or substituted with another natural or artificial sweetener and/or gelatin-like material to produce the confectionary gelatin matrix. The fish oil powder, encapsulated in gelatin (that is, the Omega 3 powder as described above in Example 1) was also added separately to the mix tank.

In another step, the ingredients were cooked to about 250° F. to about 285° F. using a standard heat exchange, such as steam injection cooker, a plate and flame heat unit, or a shell and tube heat unit. Thereafter, ingredients were cooled in a vacuum chamber to about 200° F. to produce a confectionary gelatin matrix; however, one or more of the ingredients (the corn syrup, sucrose, gelatin and/or fish oil) may be absent or substituted with another natural or artificial sweetener and/or gelatin-like material to produce the confectionary gelatin matrix. The lemon flavor, citric/lactic acid, color and remaining ingredients were added to the mixture in a mix tank. In so doing, the lemon flavor, citric/lactic acid, color and other ingredients became suspended in the confectionary gelatin matrix with the microencapsulated fish oil powder.

With the ingredients mixed, the material including the ingredients was deposited with the depositor in molds as explained above in Example 1.

As noted above, the molds may be coated with starch to prevent adherence of the material to the molds, and/or to facilitate removal of the completed gummi food products from the molds. After the gummi food products were manufactured, they were subjected to a sifter and/or screener to separate the starch from the gummi food products. The sifted or screened starch was recycled in the starch conditioner, which effectively dried the starch so that it could be reused in the mogul depositor. After the starch was separated from the gummi food products, those products were packaged using conventional packaging.

After being manufactured, the gummi-type product including the ingredients of Table III was tested by 98 subjects for aroma, appearance, sweetness, sourness, flavor, mouthfeel and overall opinion. The results of that testing is in Table IV below.

TABLE IV
Example 2 Sensory Attribute Testing

| | Aroma | | Appearance | | Sweetness | | Sourness | |
|---|---|---|---|---|---|---|---|---|
| | 98 Subjs | | 98 Subjs | | 98 Subjs | | 98 Subjs | |
| Ratings | N | % | N | % | N | % | N | % |
| Dislike Extremely (1) | 0 | 0 | 0 | 0 | 0 | 0 | 0 | 0 |
| Dislike Very Much (2) | 2 | 2 | 0 | 0 | 0 | 0 | 1 | 1 |
| Dislike Moderately (3) | 4 | 4 | 0 | 0 | 0 | 0 | 0 | 0 |
| Dislike Slightly (4) | 4 | 4 | 4 | 4 | 5 | 5 | 6 | 6 |
| Neither Like Nor | 2 | 2 | 5 | 5 | 5 | 5 | 3 | 3 |
| Dislike (5) | | | | | | | | |
| Like Slightly (6) | 12 | 12 | 11 | 11 | 12 | 12 | 10 | 10 |
| Like Moderately (7) | 26 | 27 | 30 | 31 | 21 | 21 | 19 | 19 |
| Like Very Much (8) | 33 | 34 | 36 | 37 | 37 | 38 | 41 | 42 |
| Like Extremely (9) | 15 | 15 | 12 | 12 | 18 | 18 | 18 | 18 |

| | Flavor | | Feel in Mouth | | Overall Opinion | |
|---|---|---|---|---|---|---|
| | 98 Subjs | | 98 Subjs | | 98 Subjs | |
| Ratings | N | % | N | % | N | % |
| Dislike Extremely (1) | 0 | 0 | 0 | 0 | 0 | 0 |
| Dislike Very Much (2) | 0 | 0 | 0 | 0 | 0 | 0 |
| Dislike Moderately (3) | 0 | 0 | 0 | 0 | 0 | 0 |
| Dislike Slightly (4) | 4 | 4 | 2 | 2 | 4 | 4 |
| Neither Like Nor | 3 | 3 | 5 | 5 | 2 | 2 |
| Dislike (5) | | | | | | |
| Like Slightly (6) | 9 | 9 | 7 | 7 | 8 | 8 |
| Like Moderately (7) | 21 | 21 | 26 | 27 | 25 | 26 |
| Like Very Much (8) | 43 | 44 | 42 | 43 | 41 | 42 |
| Like Extremely (9) | 18 | 18 | 16 | 16 | 18 | 18 |

According to Table IV, the aroma, appearance, sweetness, sourness, flavor and mouthfeel were generally liked moderately or very much. This indicates the absence of detectable fish aroma and/or flavor and a well-balanced sweet and sour flavor/aroma generated by the acids in flavoring.

### EXAMPLE 3

In this Example, a gummi-type product including the ingredients of Table V was manufactured and tested for sensory attributes.

TABLE V

| | % of Formula by |
|---|---|
| Ingredients | Weight |
| Corn Syrup, 42-43 D.E. | 27.94 |
| Sucrose, Fruit Granulation | 37.70 |
| Glucose Syrup, Hydrogenated | 2.47 |
| Unipectine | 0.33 |
| Gelatine 280 Bloom, Type A | 4.72 |
| Purified Water, USP | 15.36 |
| Fish Oil Powder | 7.34 |
| Acerola Concentrate Blend | 0.05 |
| Ascorbic Acid, Granular USP | 0.15 |
| T90 Mixed Tocopherols | 0.01 |
| F1000 Mixed Tocopherols | 0.03 |
| Purac CL 80% Lactic/Citric Acid | 2.50 |
| WONF Lemon Flavor | 0.25 |
| Lemonade Flavor | 1.15 |
| Total | 100.00 |

The ingredients in Table V were mixed and processed according to the following method. In one step of the method, gelatin was hydrated in water at 180° F. In another step, the pectin was added to the hydrated gelatin. The corn syrup and hydrogenated glucose syrup were added. Fish oil powder and sucrose were preblended together, and this mixture was also added.

The fish oil powder can be dried, gelatin encapsulated fish oil. Such encapsulated fish oil powder can be about 60% fish oil and about 40% gelatin. Drying may be accomplished by any number of methods, such as freeze drying, drying with ethanol or spray drying. Spray drying techniques are disclosed in “Spray Drying Handbook,” K. Masters, 5^{th} Edition, Longman Scientific Technical U.K. (1991), the disclosure of which is hereby incorporated by reference. Encapsulation of the dried fish oil powder in gelatin can be completed as described in U.S. Pat. No. 4,895,725, which is hereby incorporated by reference.

In another step, the mixed ingredients were cooked to about 265° F. using a standard direct steam injection cooker. Thereafter, the ingredients were cooled to 200° F. The lemon flavor, lemonade flavor, tocopherols, acerola concentrate and ascorbic acid were added to the mixture.

In another step, the citric/lactic acid ingredient was added to the mixture.

With the addition of the ingredients completed, the now pourable material was deposited in 3.2 gram aliquots into starch molds having cavities resembling bear characters. The material was allowed to set and form semi-solid gummy bears in the respective molds. After appropriate setting, the characters were removed, coated with oil, and packaged. The resulting gummy bears provided about 150 milligrams of omega-3 fatty acids per 4 bear serving.

After being manufactured, the gummi-type product of this Example was tested for aroma (of the product in a freshly opened packet of product), appearance (color and shape), sweetness, sourness, flavor, overall mouthfeel, overall aftertaste and overall opinion, as well as intensity of aroma, intensity of sweetness, intensity of sourness, intensity of flavor, softness of mouthfeel, chewiness of mouthfeel, perceived aftertaste, as well as other attributes, by three different age group populations, in the U.S., Japan and Korea, including adults, teenagers (13-17 year olds) and children (4-12 year olds). The number of subjects in each of the respective groups in the U.S., Japan and Korea are provided in the respective Tables below. Each attribute was measured on the respective scales in each of the Tables below. The results of the sensory testing: (a) for adults are in Tables VI, VII and VIII; (b) for teenagers are in Tables IX and X; and (c) for children is in Table XI below. In general, the products sensory attributes were liked to some degree, in many cases moderately to very much, which indicates the absence of detectable fish aroma and/or flavor, and a well-balanced sweet and sour flavor/aroma generated by the acids and flavoring.

TABLE VI
Example 3, Sensory Testing by Adults

| | Aroma (of Package) | | | | | | Appearance - Color | | | | | | Appearance - Shape | | | | | |
|---|---|---|---|---|---|---|---|---|---|---|---|---|---|---|---|---|---|---|
| | U.S. | | Japan | | Korea | | U.S. | | Japan | | Korea | | U.S. | | Japan | | Korea | |
| | 60 adults | | 56 adults | | 56 adults | | 60 adults | | 56 adults | | 56 adults | | 60 adults | | 56 adults | | 56 adults | |
| Ratings | N | % | N | % | N | % | N | % | N | % | N | % | N | % | N | % | N | % |
| Dislike Extremely (1) | 0 | 0 | 2 | 4 | 3 | 5 | 1 | 2 | 0 | 0 | 0 | 0 | 0 | 0 | 0 | 0 | 0 | 0 |
| Dislike Very Much (2) | 0 | 0 | 1 | 2 | 1 | 2 | 1 | 2 | 0 | 0 | 2 | 4 | 0 | 0 | 0 | 0 | 0 | 0 |
| Dislike Moderately (3) | 10 | 17 | 8 | 14 | 4 | 7 | 4 | 7 | 3 | 5 | 5 | 9 | 0 | 0 | 3 | 5 | 3 | 5 |
| Dislike Slightly (4) | 15 | 25 | 24 | 43 | 12 | 21 | 8 | 13 | 5 | 9 | 4 | 7 | 2 | 3 | 2 | 4 | 5 | 9 |
| Neither Like Nor | 4 | 7 | 5 | 9 | 10 | 18 | 5 | 8 | 7 | 13 | 11 | 20 | 7 | 12 | 3 | 5 | 5 | 9 |
| Dislike (5) | | | | | | | | | | | | | | | | | | |
| Like Slightly (6) | 9 | 15 | 13 | 23 | 9 | 16 | 9 | 15 | 15 | 27 | 16 | 29 | 2 | 3 | 5 | 9 | 13 | 23 |
| Like Moderately (7) | 6 | 10 | 3 | 5 | 12 | 21 | 19 | 32 | 22 | 39 | 12 | 21 | 13 | 22 | 23 | 41 | 20 | 36 |
| Like Very Much (8) | 14 | 23 | 0 | 0 | 3 | 5 | 8 | 13 | 3 | 5 | 4 | 7 | 25 | 42 | 11 | 20 | 7 | 13 |
| Like Extremely (9) | 2 | 3 | 0 | 0 | 2 | 4 | 5 | 8 | 1 | 2 | 2 | 4 | 11 | 18 | 9 | 16 | 3 | 5 |
| | Sweetness | | | | | | Sourness | | | | | | Flavor | | | | | |
| | U.S. | | Japan | | Korea | | U.S. | | Japan | | Korea | | U.S. | | Japan | | Korea | |
| | 60 adults | | 56 adults | | 56 adults | | 60 adults | | 56 adults | | 56 adults | | 60 adults | | 56 adults | | 56 adults | |
| Ratings | N | % | N | % | N | % | N | % | N | % | N | % | N | % | N | % | N | % |
| Dislike Extremely (1) | 0 | 0 | 1 | 2 | 1 | 2 | 0 | 0 | 1 | 2 | 0 | 0 | 0 | 0 | 1 | 2 | 0 | 0 |
| Dislike Very Much (2) | 0 | 0 | 0 | 0 | 1 | 2 | 0 | 0 | 0 | 0 | 3 | 5 | 0 | 0 | 0 | 0 | 1 | 2 |
| Dislike Moderately (3) | 1 | 2 | 4 | 7 | 0 | 0 | 2 | 3 | 1 | 2 | 6 | 11 | 2 | 3 | 3 | 5 | 8 | 14 |
| Dislike Slightly (4) | 4 | 7 | 3 | 5 | 3 | 5 | 6 | 10 | 5 | 9 | 9 | 16 | 6 | 10 | 8 | 14 | 6 | 11 |
| Neither Like Nor | 3 | 5 | 1 | 2 | 22 | 39 | 1 | 2 | 6 | 11 | 7 | 13 | 3 | 5 | 1 | 2 | 11 | 20 |
| Dislike (5) | | | | | | | | | | | | | | | | | | |
| Like Slightly (6) | 8 | 13 | 16 | 29 | 15 | 27 | 8 | 13 | 12 | 21 | 16 | 29 | 12 | 20 | 15 | 27 | 14 | 25 |
| Like Moderately (7) | 15 | 25 | 18 | 32 | 6 | 11 | 13 | 22 | 18 | 32 | 11 | 20 | 8 | 13 | 17 | 30 | 12 | 21 |
| Like Very Much (8) | 20 | 33 | 9 | 16 | 7 | 13 | 20 | 33 | 8 | 14 | 2 | 4 | 22 | 37 | 7 | 13 | 2 | 4 |
| Like Extremely (9) | 9 | 15 | 4 | 7 | 1 | 2 | 10 | 17 | 5 | 9 | 2 | 4 | 7 | 12 | 4 | 7 | 2 | 4 |
| | Overall Mouthfeel | | | | | | Overall Aftertaste | | | | | | Overall Opinion | | | | | |
| | U.S. | | Japan | | Korea | | U.S. | | Japan | | Korea | | U.S. | | Japan | | Korea | |
| | 60 adults | | 56 adults | | 56 adults | | 60 adults | | 56 adults | | 56 adults | | 60 adults | | 56 adults | | 56 adults | |
| Ratings | N | % | N | % | N | % | N | % | N | % | N | % | N | % | N | % | N | % |
| Dislike Extremely (1) | 0 | 0 | 0 | 0 | 0 | 0 | 0 | 0 | 1 | 2 | 0 | 0 | 0 | 0 | 0 | 0 | 0 | 0 |
| Dislike Very Much (2) | 0 | 0 | 0 | 0 | 0 | 0 | 1 | 2 | 1 | 2 | 1 | 2 | 0 | 0 | 1 | 2 | 2 | 4 |
| Dislike Moderately (3) | 1 | 2 | 2 | 4 | 3 | 5 | 1 | 2 | 1 | 2 | 9 | 16 | 1 | 2 | 1 | 2 | 4 | 7 |
| Dislike Slightly (4) | 1 | 2 | 8 | 14 | 8 | 14 | 7 | 12 | 9 | 16 | 7 | 13 | 2 | 4 | 9 | 16 | 7 | 13 |
| Neither Like Nor | 4 | 7 | 8 | 14 | 14 | 25 | 12 | 20 | 13 | 23 | 6 | 11 | 1 | 2 | 3 | 5 | 8 | 14 |
| Dislike (5) | | | | | | | | | | | | | | | | | | |
| Like Slightly (6) | 6 | 10 | 16 | 29 | 19 | 34 | 7 | 12 | 13 | 23 | 23 | 41 | 11 | 20 | 19 | 34 | 22 | 39 |
| Like Moderately (7) | 18 | 30 | 15 | 27 | 10 | 18 | 9 | 15 | 16 | 29 | 8 | 14 | 14 | 25 | 14 | 25 | 10 | 18 |
| Like Very Much (8) | 24 | 40 | 5 | 9 | 1 | 2 | 16 | 27 | 2 | 4 | 2 | 4 | 19 | 34 | 7 | 13 | 2 | 4 |
| Like Extremely (9) | 6 | 10 | 2 | 4 | 1 | 2 | 6 | 10 | 0 | 0 | 0 | 0 | 8 | 14 | 2 | 4 | 1 | 2 |

TABLE VII
Example 3, Additional Sensory Testing by Adults

| | Intensity of Aroma | | | | | | Intensity of Sweetness | | | | | |
|---|---|---|---|---|---|---|---|---|---|---|---|---|
| | U.S. | | Japan | | Korea | | U.S. | | Japan | | Korea | |
| | 60 adults | | 56 adults | | 56 adults | | 60 adults | | 56 adults | | 56 adults | |
| Ratings | N | % | N | % | N | % | N | % | N | % | N | % |
| Not Nearly Strong/Sweet | 0 | 0 | 2 | 4 | 4 | 7 | 0 | 0 | 4 | 7 | 4 | 7 |
| Enough | | | | | | | | | | | | |
| Not Quite Strong/Sweet Enough | 11 | 18 | 5 | 9 | 1 | 2 | 11 | 18 | 8 | 14 | 9 | 16 |
| Just About Right | 38 | 63 | 29 | 52 | 16 | 29 | 47 | 78 | 43 | 77 | 36 | 64 |
| Slightly Too Strong/Sweet | 10 | 17 | 19 | 34 | 30 | 54 | 2 | 3 | 1 | 2 | 7 | 13 |
| Much Too Strong/Sweet | 1 | 2 | 1 | 2 | 5 | 9 | 0 | 0 | 0 | 0 | 0 | 0 |
| | Intensity of Sourness | | | | | | Intensity of Flavor | | | | | |
| | U.S. | | Japan | | Korea | | U.S. | | Japan | | Korea | |
| | 60 adults | | 56 adults | | 56 adults | | 60 adults | | 56 adults | | 56 adults | |
| Ratings | N | % | N | % | N | % | N | % | N | % | N | % |
| Not Nearly Sour/Strong Enough | 0 | 0 | 1 | 2 | 1 | 2 | 0 | 0 | 0 | 0 | 0 | 0 |
| Not Quite Sour/Strong Enough | 5 | 8 | 3 | 5 | 5 | 9 | 5 | 8 | 2 | 4 | 6 | 11 |
| Just About Right | 45 | 75 | 31 | 55 | 11 | 20 | 52 | 87 | 40 | 71 | 20 | 36 |
| Slightly Too Sour/Strong | 10 | 17 | 18 | 32 | 33 | 59 | 3 | 5 | 13 | 23 | 28 | 50 |
| Much Too Sour/Strong | 0 | 0 | 3 | 5 | 6 | 11 | 0 | 0 | 1 | 2 | 2 | 4 |

| Mouthfeel - Softness | | |
|---|---|---|
| U.S. | Japan | Korea |
| 59 adults | 56 adults | 56 adults |

| Ratings | N | % | N | % | N | % |
|---|---|---|---|---|---|---|
| Much Too Soft | 0 | 0 | 0 | 0 | 5 | 9 |
| Slightly Too Soft | 3 | 5 | 4 | 7 | 23 | 41 |
| Just About Right | 52 | 88 | 33 | 59 | 21 | 38 |
| Slightly Too Hard | 3 | 5 | 19 | 34 | 7 | 13 |
| Much Too Hard | 1 | 2 | 0 | 0 | 0 | 0 |

| Mouthfeel - Chewiness | | |
|---|---|---|
| U.S. | Japan | Korea |
| 60 adults | 56 adults | 56 adults |

| Ratings | N | % | N | % | N | % |
|---|---|---|---|---|---|---|
| Not Nearly Chewy Enough | 0 | 0 | 0 | 0 | 0 | 0 |
| Not Quite Chewy Enough | 3 | 5 | 5 | 9 | 7 | 13 |
| Just About Right | 50 | 83 | 23 | 41 | 40 | 71 |
| Slightly Too Chewy | 6 | 10 | 24 | 43 | 9 | 16 |
| Much Too Chewy | 1 | 2 | 4 | 7 | 0 | 0 |

| How Much Aftertaste Do You | | |
|---|---|---|
| Perceive? | | |
| U.S. | Japan | Korea |
| 59 adults | 56 adults | 56 adults |

| Ratings | N | % | N | % | N | % |
|---|---|---|---|---|---|---|
| None | 15 | 25 | 2 | 4 | 1 | 2 |
| Small Amount | 27 | 46 | 32 | 57 | 28 | 51 |
| Moderate Amount | 15 | 25 | 18 | 32 | 17 | 31 |
| Large Amount | 2 | 3 | 4 | 7 | 9 | 16 |

TABLE VIII
Example 3, Additional Sensory Testing by Adults

| | | | | | | | | | | | | | This Product Tastes Like A | | | | | |
|---|---|---|---|---|---|---|---|---|---|---|---|---|---|---|---|---|---|---|
| | | | | | | | | | | | | | Lemon Drop (U.S.) | | | | | |
| | | | | | | | This Product Does Not | | | | | | This Product Has A Fine | | | | | |
| | This Product Does Not | | | | | | Have A Fishy | | | | | | Lemon Flavor (Japan and | | | | | |
| | Have A Fishy Odor | | | | | | Taste/Aftertaste | | | | | | Korea) | | | | | |
| | U.S. | | Japan | | Korea | | U.S. | | Japan | | Korea | | U.S. | | Japan | | Korea | |
| | 58 adults | | 56 adults | | 56 adults | | 58 adults | | 56 adults | | 56 adults | | 58 adults | | 56 adults | | 56 adults | |
| Ratings | N | % | N | % | N | % | N | % | N | % | N | % | N | % | N | % | N | % |
| Disagree Extremely (1) | 0 | 0 | 1 | 2 | 1 | 2 | 1 | 2 | 0 | 0 | 0 | 0 | 0 | 0 | 1 | 2 | 0 | 0 |
| Disagree Very Much (2) | 5 | 9 | 1 | 2 | 1 | 2 | 1 | 2 | 0 | 0 | 1 | 2 | 0 | 0 | 0 | 0 | 2 | 4 |
| Disagree Moderately (3) | 2 | 3 | 4 | 7 | 1 | 2 | 0 | 0 | 1 | 2 | 1 | 2 | 0 | 0 | 1 | 2 | 2 | 4 |
| Disagree Slightly (4) | 2 | 3 | 3 | 5 | 3 | 5 | 1 | 2 | 0 | 0 | 1 | 2 | 3 | 5 | 6 | 11 | 2 | 4 |
| Neither Agree Nor | 0 | 0 | 3 | 5 | 4 | 7 | 1 | 2 | 2 | 4 | 5 | 9 | 0 | 0 | 4 | 7 | 4 | 7 |
| Disagree (5) | | | | | | | | | | | | | | | | | | |
| Agree Slightly (6) | 3 | 5 | 5 | 9 | 4 | 7 | 1 | 2 | 7 | 13 | 3 | 5 | 8 | 14 | 13 | 23 | 11 | 20 |
| Agree Moderately (7) | 6 | 10 | 18 | 32 | 10 | 18 | 7 | 12 | 23 | 41 | 14 | 25 | 15 | 26 | 15 | 27 | 17 | 30 |
| Agree Very Much (8) | 19 | 33 | 7 | 13 | 6 | 11 | 23 | 40 | 7 | 13 | 2 | 4 | 19 | 33 | 11 | 20 | 9 | 16 |
| Agree Extremely (9) | 21 | 36 | 14 | 25 | 26 | 46 | 23 | 40 | 16 | 29 | 29 | 52 | 13 | 22 | 5 | 9 | 9 | 16 |
| % Disagree | 16 | | 16 | | 11 | | 5 | | 2 | | 5 | | 5 | | 14 | | 11 | |
| % Agree | 84 | | 79 | | 82 | | 93 | | 95 | | 86 | | 95 | | 79 | | 82 | |
| % Neither Agree Nor | 0 | | 5 | | 7 | | 2 | | 4 | | 9 | | 0 | | 7 | | 7 | |
| Disagree | | | | | | | | | | | | | | | | | | |
| | This Product Tastes Like | | | | | | | | | | | | | | | | | |
| | Candy (U.S.) | | | | | | This Product Is Easy To | | | | | | | | | | | |
| | This Product Is Refreshing | | | | | | Chew (U.S.) | | | | | | | | | | | |
| | To Your Mouth (Japan and | | | | | | This Product Is Easy To | | | | | | This Product Is Easy To | | | | | |
| | Korea) | | | | | | Take (Japan and Korea) | | | | | | Swallow (U.S.) | | | | | |
| | U.S. | | Japan | | Korea | | U.S. | | Japan | | Korea | | U.S. | | | | | |
| | 58 adults | | 56 adults | | 56 adults | | 58 adults | | 56 adults | | 56 adults | | 58 adults | | Japan | | Koreas | |
| Ratings | N | % | N | % | N | % | N | % | N | % | N | % | N | % | N | % | N | % |
| Disagree Extremely (1) | 0 | 0 | 2 | 4 | 0 | 0 | 1 | 2 | 1 | 2 | 0 | 0 | 0 | 0 | na | na | na | na |
| Disagree Very Much (2) | 0 | 0 | 0 | 0 | 2 | 4 | 0 | 0 | 0 | 0 | 0 | 0 | 0 | 0 | na | na | na | na |
| Disagree Moderately (3) | 0 | 0 | 2 | 4 | 8 | 14 | 2 | 3 | 1 | 2 | 1 | 2 | 0 | 0 | na | na | na | na |
| Disagree Slightly (4) | 5 | 9 | 3 | 5 | 5 | 9 | 1 | 2 | 4 | 7 | 0 | 0 | 0 | 0 | na | na | na | na |
| Neither Agree Nor | 0 | 0 | 13 | 23 | 6 | 11 | 1 | 2 | 4 | 7 | 7 | 13 | 1 | 2 | na | na | na | na |
| Disagree (5) | | | | | | | | | | | | | | | | | | |
| Agree Slightly (6) | 10 | 17 | 19 | 34 | 14 | 25 | 3 | 5 | 14 | 25 | 13 | 23 | 2 | 3 | na | na | na | na |
| Agree Moderately (7) | 11 | 19 | 12 | 21 | 18 | 32 | 8 | 14 | 15 | 27 | 23 | 41 | 11 | 19 | na | na | na | na |
| Agree Very Much (8) | 19 | 33 | 3 | 5 | 2 | 4 | 26 | 45 | 11 | 20 | 11 | 20 | 26 | 45 | na | na | na | na |
| Agree Extremely (9) | 13 | 22 | 2 | 4 | 1 | 2 | 16 | 28 | 6 | 11 | 1 | 2 | 18 | 31 | na | na | na | na |

| | | | | | | | | | |
|---|---|---|---|---|---|---|---|---|---|
| % Disagree | 9 | 13 | 27 | 7 | 11 | 2 | 0 | na | na |
| % Agree | 91 | 64 | 63 | 91 | 82 | 86 | 98 | na | na |
| % Neither Agree Nor | 0 | 23 | 11 | 2 | 7 | 13 | 2 | na | na |
| Disagree | | | | | | | | | |

TABLE IX
Example 3, Sensory Testing by Teens

| | Aroma (of Package) | | | | | | Appearance - Color | | | | | | Appearance - Shape | | | | | |
|---|---|---|---|---|---|---|---|---|---|---|---|---|---|---|---|---|---|---|
| | U.S. | | Japan | | Korea | | U.S. | | Japan | | Korea | | U.S. | | Japan | | Korea | |
| | 31 | | 34 | | 29 | | 31 | | 34 | | 29 | | 31 | | 34 | | 27 | |
| | teens | | teens | | teens | | teens | | teens | | teens | | teens | | teens | | teens | |
| Ratings | N | % | N | % | N | % | N | % | N | % | N | % | N | % | N | % | N | % |
| Dislike Extremely (1) | 0 | 0 | 3 | 9 | 6 | 21 | 0 | 0 | 1 | 3 | 2 | 7 | 0 | 0 | 1 | 3 | 1 | 4 |
| Dislike Very Much (2) | 1 | 3 | 3 | 9 | 3 | 10 | 0 | 0 | 0 | 0 | 1 | 3 | 0 | 0 | 0 | 0 | 0 | 0 |
| Dislike Moderately (3) | 5 | 16 | 4 | 12 | 3 | 10 | 5 | 16 | 0 | 0 | 2 | 7 | 0 | 0 | 2 | 6 | 1 | 4 |
| Dislike Slightly (4) | 14 | 45 | 9 | 26 | 5 | 17 | 2 | 6 | 2 | 6 | 1 | 3 | 0 | 0 | 0 | 0 | 1 | 4 |
| Neither Like Nor | 3 | 10 | 3 | 9 | 3 | 10 | 12 | 39 | 7 | 21 | 6 | 21 | 1 | 3 | 3 | 9 | 1 | 4 |
| Dislike (5) | | | | | | | | | | | | | | | | | | |
| Like Slightly (6) | 4 | 13 | 5 | 15 | 2 | 7 | 4 | 13 | 9 | 26 | 4 | 14 | 2 | 6 | 8 | 24 | 1 | 4 |
| Like Moderately (7) | 1 | 3 | 6 | 18 | 1 | 3 | 6 | 19 | 11 | 32 | 7 | 24 | 8 | 26 | 9 | 26 | 11 | 41 |
| Like Very Much (8) | 3 | 10 | 1 | 3 | 3 | 10 | 2 | 6 | 3 | 9 | 2 | 7 | 14 | 45 | 4 | 12 | 6 | 22 |
| Like Extremely (9) | 0 | 0 | 0 | 0 | 3 | 10 | 0 | 0 | 1 | 3 | 4 | 14 | 6 | 19 | 7 | 21 | 5 | 19 |
| | Sweetness | | | | | | Sourness | | | | | | Flavor | | | | | |
| | U.S. | | Japan | | Korea | | U.S. | | Japan | | Korea | | U.S. | | Japan | | Korea | |
| | 31 | | 34 | | 29 | | 31 | | 34 | | 29 | | 31 | | 34 | | 29 | |
| | teens | | teens | | teens | | teens | | teens | | teens | | teens | | teens | | teens | |
| Ratings | N | % | N | % | N | % | N | % | N | % | N | % | N | % | N | % | N | % |
| Dislike Extremely (1) | 0 | 0 | 2 | 6 | 2 | 7 | 0 | 0 | 2 | 6 | 4 | 14 | 0 | 0 | 2 | 6 | 4 | 14 |
| Dislike Very Much (2) | 0 | 0 | 1 | 3 | 3 | 10 | 0 | 0 | 1 | 3 | 3 | 10 | 2 | 6 | 3 | 9 | 2 | 7 |
| Dislike Moderately (3) | 2 | 6 | 2 | 6 | 4 | 14 | 0 | 0 | 3 | 9 | 1 | 3 | 3 | 10 | 2 | 6 | 2 | 7 |
| Dislike Slightly (4) | 3 | 10 | 3 | 9 | 0 | 0 | 7 | 23 | 3 | 9 | 4 | 14 | 3 | 10 | 3 | 9 | 3 | 10 |
| Neither Like Nor | 2 | 6 | 3 | 9 | 9 | 31 | 4 | 13 | 4 | 12 | 5 | 17 | 3 | 10 | 5 | 15 | 9 | 31 |
| Dislike (5) | | | | | | | | | | | | | | | | | | |
| Like Slightly (6) | 8 | 26 | 13 | 38 | 3 | 10 | 7 | 23 | 8 | 24 | 4 | 14 | 5 | 16 | 4 | 12 | 2 | 7 |
| Like Moderately (7) | 6 | 19 | 6 | 18 | 6 | 21 | 8 | 26 | 7 | 21 | 6 | 21 | 10 | 32 | 10 | 29 | 3 | 10 |
| Like Very Much (8) | 7 | 23 | 4 | 12 | 1 | 3 | 4 | 13 | 4 | 12 | 1 | 3 | 4 | 13 | 4 | 12 | 3 | 10 |
| Like Extremely (9) | 3 | 10 | 0 | 0 | 1 | 3 | 1 | 3 | 2 | 6 | 1 | 3 | 1 | 3 | 1 | 3 | 1 | 3 |
| | Overall Mouthfeel | | | | | | Overall Aftertaste | | | | | | Overall Opinion | | | | | |
| | U.S. | | Japan | | Korea | | U.S. | | Japan | | Korea | | U.S. | | Japan | | Korea | |
| | 31 | | 34 | | 28 | | 31 | | 34 | | 29 | | 31 | | 34 | | 29 | |
| | teens | | teens | | teens | | teens | | teens | | teens | | teens | | teens | | teens | |
| Ratings | N | % | N | % | N | % | N | % | N | % | N | % | N | % | N | % | N | % |
| Dislike Extremely (1) | 0 | 0 | 1 | 3 | 2 | 7 | 1 | 3 | 2 | 6 | 5 | 17 | 0 | 0 | 2 | 6 | 3 | 10 |
| Dislike Very Much (2) | 0 | 0 | 1 | 3 | 1 | 3 | 1 | 3 | 0 | 0 | 1 | 3 | 1 | 3 | 1 | 3 | 3 | 10 |
| Dislike Moderately (3) | 1 | 3 | 1 | 3 | 2 | 7 | 2 | 6 | 4 | 12 | 3 | 10 | 2 | 6 | 3 | 9 | 2 | 7 |
| Dislike Slightly (4) | 2 | 6 | 4 | 12 | 6 | 21 | 3 | 10 | 4 | 12 | 6 | 21 | 4 | 13 | 3 | 9 | 1 | 3 |
| Neither Like Nor | 0 | 0 | 5 | 15 | 9 | 31 | 8 | 26 | 8 | 24 | 6 | 21 | 3 | 10 | 4 | 12 | 6 | 21 |
| Dislike (5) | | | | | | | | | | | | | | | | | | |
| Like Slightly (6) | 7 | 23 | 10 | 29 | 2 | 7 | 9 | 29 | 6 | 18 | 3 | 10 | 1 | 3 | 10 | 29 | 5 | 17 |
| Like Moderately (7) | 10 | 32 | 8 | 24 | 5 | 17 | 4 | 13 | 10 | 29 | 3 | 10 | 12 | 39 | 8 | 24 | 4 | 14 |
| Like Very Much (8) | 8 | 26 | 4 | 12 | 0 | 0 | 3 | 10 | 0 | 0 | 1 | 3 | 5 | 16 | 3 | 9 | 5 | 17 |
| Like Extremely (9) | 3 | 10 | 0 | 0 | 1 | 3 | 0 | 0 | 0 | 0 | 1 | 3 | 3 | 10 | 0 | 0 | 0 | 0 |

TABLE X
Example 3, Additional Sensory Testing by Teens

| | Intensity of Aroma | | | | | | Intensity of Sweetness | | | | | |
|---|---|---|---|---|---|---|---|---|---|---|---|---|
| | U.S. | | Japan | | Korea | | U.S. | | Japan | | Korea | |
| | 31 | | 34 | | 29 | | 31 | | 34 | | 29 | |
| | teens | | teens | | teens | | teens | | teens | | teens | |
| Ratings | N | % | N | % | N | % | N | % | N | % | N | % |
| Not Nearly Strong/Sweet | 0 | 0 | 2 | 6 | 0 | 0 | 1 | 3 | 0 | 0 | 3 | 10 |
| Enough | | | | | | | | | | | | |
| Not Quite Strong/Sweet Enough | 1 | 3 | 4 | 12 | 5 | 17 | 5 | 16 | 11 | 32 | 8 | 28 |
| Just About Right | 14 | 45 | 10 | 29 | 4 | 14 | 19 | 61 | 21 | 62 | 15 | 52 |
| Slightly Too Strong/Sweet | 13 | 42 | 16 | 47 | 16 | 55 | 6 | 19 | 2 | 6 | 2 | 7 |
| Much Too Strong/Sweet | 3 | 10 | 2 | 6 | 4 | 14 | 0 | 0 | 0 | 0 | 1 | 3 |
| | Intensity of Sourness | | | | | | Intensity of Flavor | | | | | |
| | U.S. | | Japan | | Korea | | U.S. | | Japan | | Korea | |
| | 31 | | 34 | | 29 | | 31 | | 34 | | 29 | |
| | teens | | teens | | teens | | teens | | teens | | teens | |
| Ratings | N | % | N | % | N | % | N | % | N | % | N | % |
| Not Nearly Sour/Strong Enough | 0 | 0 | 2 | 6 | 4 | 14 | 0 | 0 | 0 | 0 | 2 | 7 |
| Not Quite Sour/Strong Enough | 6 | 19 | 6 | 18 | 5 | 17 | 8 | 26 | 5 | 15 | 5 | 17 |
| Just About Right | 20 | 65 | 15 | 44 | 9 | 31 | 18 | 58 | 14 | 41 | 10 | 34 |
| Slightly Too Sour/Strong | 5 | 16 | 11 | 32 | 9 | 31 | 4 | 13 | 12 | 35 | 9 | 31 |
| Much Too Sour/Strong | 0 | 0 | 0 | 0 | 2 | 7 | 1 | 3 | 3 | 9 | 3 | 10 |

| Mouthfeel - Softness | | |
|---|---|---|
| U.S. | Japan | Korea |
| 31 teens | 34 teens | 27 teens |

| Ratings | N | % | N | % | N | % |
|---|---|---|---|---|---|---|
| Much Too Soft | 0 | 0 | 0 | 0 | 5 | 17 |
| Slightly Too Soft | 1 | 3 | 4 | 12 | 15 | 52 |
| Just About Right | 25 | 81 | 22 | 65 | 6 | 21 |
| Slightly Too Hard | 5 | 16 | 8 | 24 | 3 | 10 |
| Much Too Hard | 0 | 0 | 0 | 0 | 0 | 0 |

| Mouthfeel - Chewiness | | |
|---|---|---|
| U.S. | Japan | Korea |
| 31 teens | 34 teens | 28 teens |

| Ratings | N | % | N | % | N | % |
|---|---|---|---|---|---|---|
| Not Nearly Chewy Enough | 0 | 0 | 1 | 3 | 1 | 3 |
| Not Quite Chewy Enough | 8 | 26 | 4 | 12 | 8 | 28 |
| Just About Right | 20 | 65 | 14 | 41 | 16 | 55 |
| Slightly Too Chewy | 3 | 10 | 14 | 41 | 4 | 14 |
| Much Too Chewy | 0 | 0 | 1 | 3 | 0 | 0 |

| How Much Aftertaste Do | | |
|---|---|---|
| You Perceive? | | |
| U.S. | Japan | Korea |
| 31 teens | 34 teens | 27 teens |

| Ratings | N | % | N | % | N | % |
|---|---|---|---|---|---|---|
| None | 1 | 3 | 2 | 6 | 6 | 22 |
| Small Amount | 17 | 55 | 17 | 50 | 15 | 56 |
| Moderate Amount | 9 | 29 | 10 | 29 | 2 | 7 |
| Large Amount | 4 | 13 | 5 | 15 | 4 | 15 |

| Would You Ask Your Mom | | |
|---|---|---|
| Or Dad To Buy This | | |
| Product For You? | | |
| U.S. | | |
| 30 teens | Japan | Korea |

| Ratings | N | % | N | % | N | % |
|---|---|---|---|---|---|---|
| Yes | 21 | 70 | na | na | na | na |
| No | 9 | 30 | na | na | na | na |

TABLE XI
Example 3, Sensory Testing by Children

| | Aroma (of Package) | | | | | | Appearance - Color | | | | | | Appearance - Shape | | | | | |
|---|---|---|---|---|---|---|---|---|---|---|---|---|---|---|---|---|---|---|
| | U.S. | | Japan | | Korea | | U.S. | | Japan | | Korea | | U.S. | | Japan | | Korea | |
| | 37 | | 34 | | 29 | | 37 | | 34 | | 29 | | 37 | | 34 | | 29 | |
| | child | | child | | child | | child | | child | | child | | child | | child | | child | |
| Ratings | N | % | N | % | N | % | N | % | N | % | N | % | N | % | N | % | N | % |
| Really Bad (1) | 2 | 5 | 0 | 0 | 2 | 7 | 0 | 0 | 0 | 0 | 0 | 0 | 0 | 0 | 1 | 3 | 1 | 3 |
| Bad (2) | 4 | 11 | 6 | 18 | 2 | 7 | 2 | 5 | 2 | 6 | 1 | 3 | 0 | 0 | 2 | 6 | 2 | 7 |
| O.K. (3) | 4 | 11 | 7 | 21 | 4 | 14 | 7 | 19 | 9 | 26 | 7 | 24 | 1 | 3 | 4 | 12 | 3 | 10 |
| Good (4) | 11 | 30 | 14 | 41 | 15 | 52 | 19 | 51 | 14 | 41 | 18 | 62 | 10 | 27 | 11 | 32 | 13 | 45 |
| Really Good (5) | 16 | 43 | 7 | 21 | 6 | 21 | 9 | 24 | 9 | 26 | 3 | 10 | 26 | 70 | 16 | 47 | 10 | 34 |
| | Flavor | | | | | | Overall Texture/Mouthfeel | | | | | | Overall Aftertaste | | | | | |
| | U.S. | | Japan | | Korea | | U.S. | | Japan | | Korea | | U.S. | | Japan | | Korea | |
| | 37 | | 34 | | 29 | | 37 | | 34 | | 29 | | 37 | | 34 | | 29 | |
| | child | | child | | child | | child | | child | | child | | child | | child | | child | |
| Ratings | N | % | N | % | N | % | N | % | N | % | N | % | N | % | N | % | N | % |
| Really Bad (1) | 3 | 8 | 3 | 9 | 0 | 0 | 1 | 3 | 1 | 3 | 0 | 0 | 4 | 11 | 4 | 12 | 0 | 0 |
| Bad (2) | 4 | 11 | 4 | 12 | 1 | 3 | 2 | 5 | 6 | 18 | 3 | 10 | 3 | 8 | 4 | 12 | 2 | 7 |
| O.K. (3) | 5 | 14 | 7 | 21 | 6 | 21 | 9 | 24 | 10 | 30 | 5 | 17 | 8 | 22 | 9 | 27 | 5 | 17 |
| Good (4) | 10 | 27 | 8 | 24 | 11 | 38 | 9 | 24 | 10 | 30 | 18 | 62 | 11 | 30 | 9 | 27 | 15 | 52 |
| Really Good (5) | 15 | 41 | 12 | 35 | 11 | 38 | 16 | 43 | 6 | 18 | 3 | 10 | 11 | 30 | 7 | 21 | 7 | 24 |

| Overall Opinion | | |
|---|---|---|
| U.S. | Japan | Korea |
| 37 child | 34 child | 29 child |

| Ratings | N | % | N | % | N | % |
|---|---|---|---|---|---|---|
| Really Bad (1) | 1 | 3 | 3 | 9 | 0 | 0 |
| Bad (2) | 5 | 14 | 7 | 21 | 1 | 3 |
| O.K. (3) | 6 | 16 | 4 | 12 | 3 | 10 |
| Good (4) | 9 | 24 | 7 | 21 | 18 | 62 |
| Really Good (5) | 16 | 43 | 13 | 38 | 7 | 24 |

| Would You Ask Your Mom | | |
|---|---|---|
| Or Dad To Buy This | | |
| Product For You? | | |
| U.S. | | |
| 36 child | Japan | Korea |

| | N | % | N | % | N | % |
|---|---|---|---|---|---|---|
| Yes | 22 | 61 | na | na | na | na |
| No | 14 | 39 | na | na | na | na |

### EXAMPLE 4

In this example, the gummi-type product including the ingredients of Table III was manufactured according to the method described in Example 3. The product was then tested by the same test subjects in Example 3 for different claim attributes of the food product. These claim attributes and the respective questions, as well as their results—agree, disagree and neither agree nor disagree—are presented in Table XII below. As a result of this assessment, it was determined that the fishy odor and/or aftertaste and taste was generally masked to a satisfactory degree in the gummi food products.

TABLE XII

| | U.S. | Japan | Korea |
|---|---|---|---|
| This product does not have a fishy odor. | | | |
| Agree | 84% | 79% | 82% |
| Disagree | 16% | 16% | 11% |
| Neither Agree Nor Disagree | 0% | 5% | 7% |
| This product does not have a fishy taste/aftertaste. | | | |
| Agree | 84% | 79% | 82% |
| Disagree | 16% | 16% | 11% |
| Neither Agree Nor Disagree | 0% | 5% | 7% |
| This product has a fine lemon flavor. | | | |
| Agree | N/A | 79% | 82% |
| Disagree | N/A | 14% | 11% |
| Neither Agree Nor Disagree | N/A | 7% | 7% |
| This product is refreshing to your mouth. | | | |
| Agree | N/A | 64% | 63% |
| Disagree | N/A | 13% | 27% |
| Neither Agree Nor Disagree | N/A | 23% | 11% |
| This product is easy to take. | | | |
| Agree | N/A | 82% | 86% |
| Disagree | N/A | 11% | 2% |
| Neither Agree Nor Disagree | N/A | 7% | 13% |
| This product tastes like a lemon drop. | | | |
| Agree | 95% | N/A | N/A |
| Disagree | 5% | N/A | N/A |
| Neither Agree Nor Disagree | 0% | N/A | N/A |
| This product tastes like candy. | | | |
| Agree | 91% | N/A | N/A |
| Disagree | 9% | N/A | N/A |
| Neither Agree Nor Disagree | 0% | N/A | N/A |
| This product is easy to chew. | | | |
| Agree | 91% | N/A | N/A |
| Disagree | 7% | N/A | N/A |
| Neither Agree Nor Disagree | 2% | N/A | N/A |
| This product is easy to swallow. | | | |
| Agree | 98% | N/A | N/A |
| Disagree | 0% | N/A | N/A |
| Neither Agree Nor Disagree | 2% | N/A | N/A |

### EXAMPLE 5

In this example, a gummi-type product will be manufactured to include the ingredients in Table XIII.

TABLE XIII

| | % of Formula |
|---|---|
| Ingredient | by Weight |
| Corn Syrup, 42-43 D.E. | 34.79 |
| Sucrose, Fruit Granulation | 33.65 |
| Crystaline Sorbitol | 1.00 |
| Pectin | 0.50 |
| Gelatine, porcine | 4.72 |
| Water, Purified | 12.92 |
| Omega 3, DHA powder | 7.34 |
| Acerola Concentrate, Blend | 0.05 |
| Ascorbic Acid, Granular, USP | 0.15 |
| Tocopherols, Natural mixed | 0.01 |
| Vitamin E, d-α-tocopherol, 67% | 0.05 |
| Citric/Lactic Acid Solution | 3.10 |
| Natural Mango Flavor | 1.40 |
| Lemon Flavor | 0.10 |
| Carnauba Wax | 0.06 |
| Caramel Color | 0.20 |
| Total | 100.00 |

The above ingredients will be mixed to form a gummi food product using the method similar to that in Example 3. In addition, the mango flavoring will be suspended with the citric/lactic acid neutralizing agent in the gummi-type confectionary gelatin matrix including the corn syrup, sucrose and gelatin.

Sensory testing of the food product including the ingredients of Table XIII is expected to indicate an absence of detectable fish aroma and/or flavor, and a well-balanced flavor/aroma generated by the acids and flavoring.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Except in the claims and the specific examples, or where otherwise expressly indicated, all numerical quantities in this description indicating amounts of material, reaction conditions, use conditions, and the like, are to be understood as modified by the word “about” in describing the broadest scope of the invention. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A food product comprising:
at least one omega-3 fatty acid component substantially microencapsulated in a microencapsulating gelatin;
at least one of corn syrup, glucose syrup and sucrose;
a citric acid present in an amount of about 0.8% to about 4% by weight of the food product;
confectionary gelatin matrix; and
a lemon flavoring agent present in about 0.02% to about 2% by weight of the food product, wherein the microencapsulated omega-3 fatty acid component, citric acid and lemon flavoring agent are suspended in the confectionary gelatin matrix.

2. The food product of claim 1 wherein the omega-3 fatty acid component is derived from a fish oil.

3. The food product of claim 2 wherein the fish oil is present in an amount of about 7% to about 7.5% by weight of the food product.

4. The food product of claim 2 wherein the fish oil is present in an amount of no more than about 8% by weight of the food product.

5. The food product of claim 1 comprising tocopherols.

6. The food product of claim 1 comprising a lemonade flavoring agent present in an amount of about 0.5% to about 1.75% by weight of the food product.

7. The food product of claim 1 comprising a mango flavoring agent present in an amount of about 0.5% to about 3% by weight of the food product.

8. The food product of claim 1 wherein the omega-3 fatty acid component is a powder including fish oil and a gelatin.

9. The food product of claim 1 wherein the citric acid is present in an amount of about 0.8% by weight of the food product.

10. The food product of claim 1 wherein the at least one omega-3 fatty acid component is present in an amount of at least about 7% by weight of the food product.

11. A food product comprising:
at least one omega-3 fatty acid derived from a fish oil having at least one of a fish flavor and a fish aroma;
a neutralizing agent for neutralizing at least one of a fish flavor and a fish aroma, wherein the neutralizing agent comprises a food grade acid in an amount of about 1% to about 4% by weight of the composition; and
at least one of a lemon flavoring agent and a mango flavoring agent present in an amount of about 0.02% to about 5.5% by weight of the composition,
wherein the omega-3 fatty acid, neutralizing agent and at least one of a lemon flavoring agent and a mango flavoring agent are suspended in a gummi-type gelatin matrix.

12. The food product of claim 11 wherein the food grade acid is at least one of citric acid, lactic acid, malic acid, ascorbic acid and phosphoric acid.

13. The food product of claim 11 comprising lemonade flavor and at least one polyalcohol.

14. The food product of claim 11 wherein the fish oil is microencapsulated in a first gelatin, and wherein the microencapsulated fish oil and neutralizing agent are suspended in a confectionary gelatin matrix.

15. The food product of claim 11 comprising at least one of monosaccharides, disaccharides and polysaccharides.

16. The food product of claim 11 wherein the fish oil is microencapsulated in a first gelatin to form fish oil microcapsules.

17. The food product of claim 16 wherein the fish oil microcapsules are dispersed in a second gelatin.

18. The food product of claim 11 wherein the food grade acid is citric acid present in an amount of about 0.8% to about 4% by weight of the food product.

19. The food product of claim 11 wherein the fish oil is present in an amount of about 7% to about 7.5% by weight of the food product.

20. The food product of claim 11 wherein the fish oil is present in an amount of no more than about 8% by weight of the food product.

21. A method for manufacturing a food product comprising:
providing an omega-3 fatty acid component substantially microencapsulated in a microencapsulating gelatin;
mixing citric acid in an amount of about 0.8% to about 4% by weight of food product with the microencapsulated omega-3 fatty acid component;
mixing lemon flavoring in an amount of about 0.02% to about 2% by weight of the food product with the microencapsulated omega-3 fatty acid component; and
suspending the microencapsulated omega-3 fatty acid component, the citric acid and the lemon flavoring in a gelatin matrix to form a gummi food product.

22. The method of claim 21 comprising mixing mango flavoring in the gelatin matrix in an amount of about 0.5% to about 3% by weight of the food product.

23. The method of claim 21 comprising mixing lemonade flavoring in the gelatin matrix in an amount of about 0.5% to about 3.5% by weight of the food product.

24. The method of claim 21 wherein the microencapsulated omega-3 fatty acid component is present in an amount of about no more than 8% by weight of the food product, the lemon flavoring is present in an amount of about 0.25% by weight of the food product, and the citric acid is present in an amount of about 0.8% by weight of the food product.
